(19) United States
(12) Patent Application Publication
(10) Pub. No.: US 2021/0054911 A1
(43) Pub. Date: Feb. 25, 2021

(54) Planetary Gear Set Transmission Apparatus

(71) Applicant: John Kruse, Casper, WY (US)

(72) Inventor: John Kruse, Casper, WY (US)

(21) Appl. No.: 16/545,488

(22) Filed: Aug. 20, 2019

(51) Int. Cl. F16H 3/72; B60K 6/365

(52) U.S. Cl. CPC F16H 3/727; F16H 2200/2005; B60K 6/365

(57) ABSTRACT

A planetary gear set transmission apparatus for providing a variable speed drive with no clutch includes a planet carrier having a set of evenly spaced arms. An input shaft is coupled to the planet carrier and is configured to be connected to an engine. A set of planet gears is coupled to the planet carrier. Each planet gear has a planet axle. A ring gear is coupled to the set of planet gears. A sun gear is coupled to the set of planet gears. An output shaft is coupled to the sun gear. A generator gear is coupled to the ring gear and is in operational communication with the plurality of outer teeth. A generator is coupled to the generator gear and has a generator drive shaft coupled through the generator gear. The generator is used to brake the ring gear and control the speed of the sun gear.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to transmissions and more particularly pertains to a new transmission for providing a variable speed drive with no clutch.

### (2) Description of Related Art Including Information Disclosed Under 37 CFR 1.97 and 1.98.

The prior art relates to transmissions.

### BRIEF SUMMARY OF THE INVENTION

An embodiment of the disclosure meets the needs presented above by generally comprising a planet carrier having a carrier outer side and a carrier inner side. The planet carrier has a set of evenly spaced arms. An input shaft is coupled to the carrier outer side and is configured to be connected to an engine. A set of planet gears is coupled to the planet carrier. Each planet gear has a planet axle rotatably coupled to the carrier inner side of one of the arms of the planet carrier. A ring gear is coupled to the set of planet gears. The ring gear has a plurality of inner teeth and a plurality of outer teeth. The plurality of inner teeth is in operational communication with each of the planet gears. A sun gear is coupled to the set of planet gears. The sun gear is concentrically disposed within the ring gear adjacent the planet carrier and is in operational communication with each of the planet gears. An output shaft is coupled to the sun gear and lies coaxially with the input shaft. A generator gear is coupled to the ring gear and is in operational communication with the plurality of outer teeth. A generator is coupled to the generator gear and has a generator drive shaft centrally coupled through the generator gear.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a planetary gear set transmission apparatus according to an embodiment of the disclosure.

FIG. 2 is a side elevation view of an embodiment of the disclosure.

FIG. 3 is a front elevation view of an embodiment of the disclosure.

FIG. 4 is a cross-sectional view along the line 4-4 of FIG. 2 of an embodiment of the disclosure.

### DETAILED DESCRIPTION OF THE INVENTION

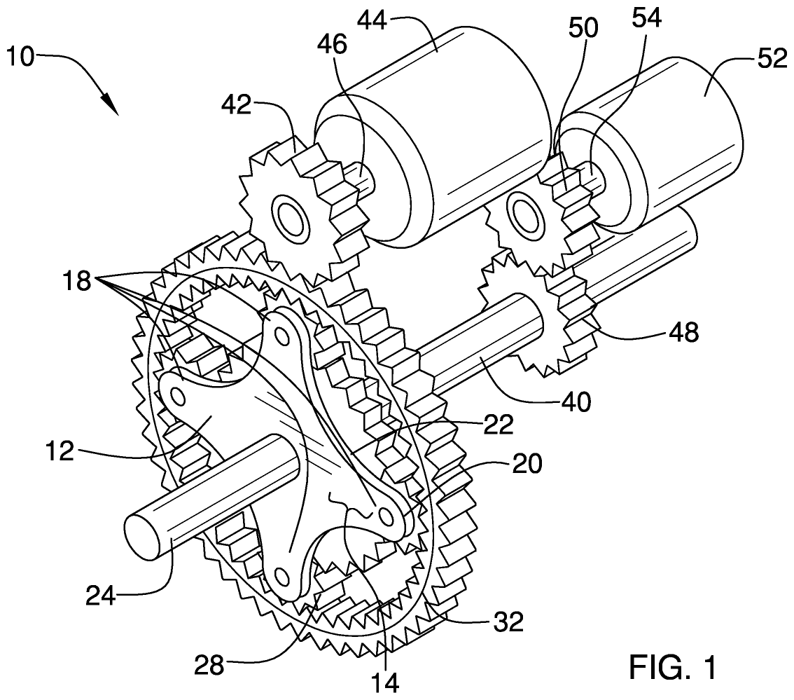

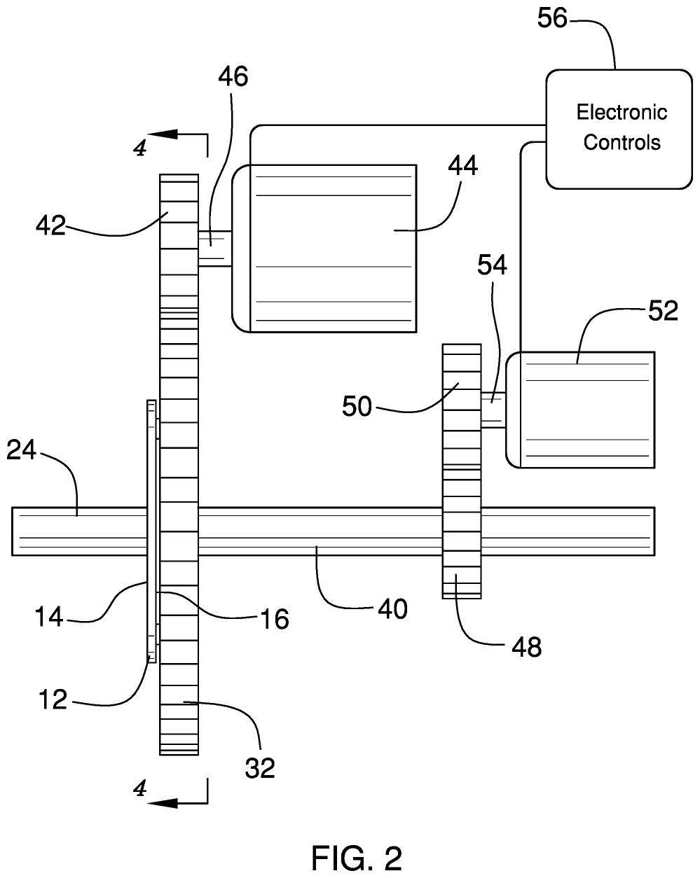

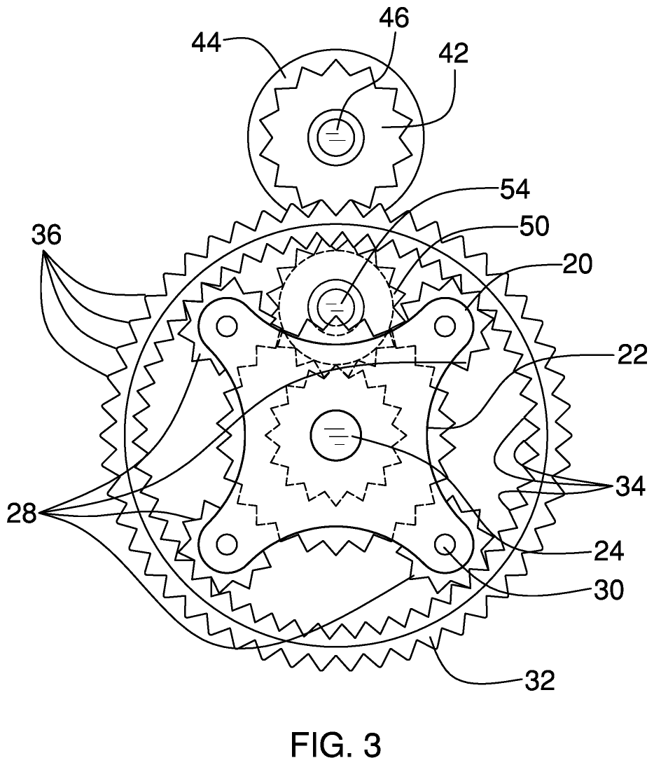

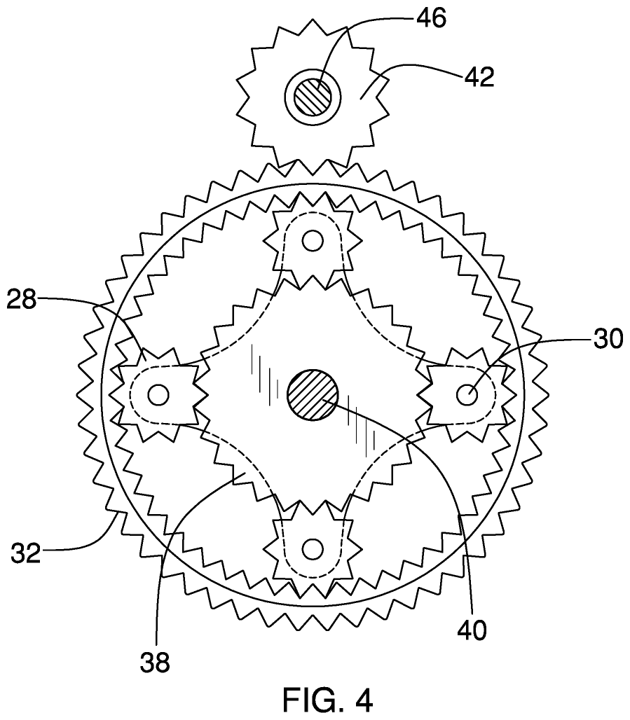

With reference now to the drawings, and in particular to FIGS. 1 through 4 thereof, a new transmission embodying the principles and concepts of an embodiment of the disclosure and generally designated by the reference numeral 10 will be described.

As best illustrated in FIGS. 1 through 4, the planetary gear set transmission apparatus 10 generally comprises a planet carrier 12 having a carrier outer side 14 and a carrier inner side 16. The planet carrier 12 has a set of evenly spaced arms 18. The set of arms 18 may be four arms. An outer end 20 of each of the arms 18 is rounded and a span 22 between each of the arms 18 is concave outwards. An input shaft 24 is coupled to the carrier outer side 14 and is configured to be connected to an engine. A set of planet gears 28 is coupled to the planet carrier 12. Each planet gear 28 has a planet axle 30 rotatably coupled to the carrier inner side 16 of one of the arms 18 of the planet carrier 12. A ring gear 32 is coupled to the set of planet gears 28. The ring gear 32 has a plurality of inner teeth 34 and a plurality of outer teeth 36. The plurality of inner teeth 34 is in operational communication with each of the planet gears 28. A sun gear 38 is coupled to the set of planet gears 28. The sun gear 38 is concentrically disposed within the ring gear 32 adjacent the planet carrier 12 and is in operational communication with each of the planet gears 28. An output shaft 40 is coupled to the sun gear 38 and lies coaxially with the input shaft 24. A generator gear 42 is coupled to the ring gear 32 and is in operational communication with the plurality of outer teeth 36. A generator 44 is coupled to the generator gear 42. The generator 44 has a generator drive shaft 46 centrally coupled through the generator gear 42. A shaft gear 48 is coupled to the output shaft 40 and extends centrally through the shaft gear 48. A motor gear 50 is coupled to the shaft gear 48 and is in operational communication with the shaft gear 48. A motor 52 is coupled to the motor gear 50 and has a motor drive shaft 54 centrally coupled through the motor gear 50. An electric controller 56 is in operational communication with each of the generator 44 and the motor 52 to draw energy from the generator 44 to power the motor 52.

In use, with the planet carrier 12 driven at a steady RPM and no load on the generator 44, the ring gear 32 turns freely and no power goes to the sun gear 38. When an electrical load is applied to the generator 44 it slows the ring gear 32 and drives the sun gear 38 and the output shaft 40. The electric controller 56 is used to control the electrical load on the generator 44 and hence the torque required to turn the generator gear 42, braking the ring gear 32 as desired. The electrical energy created by the generator 44 can in turn be used to power the motor 52 and drive the motor gear 50 and the shaft gear 48, thus preventing energy waste from braking the ring gear 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A planetary gear set transmission apparatus comprising:
a planet carrier, the planet carrier having a carrier outer side and a carrier inner side, the planet carrier having a set of evenly spaced arms;
an input shaft coupled to the planet carrier, the input shaft being coupled to the carrier outer side and configured to be connected to an engine;
a set of planet gears coupled to the planet carrier, each planet gear having a planet axle rotatably coupled to the carrier inner side of one of the arms of the planet carrier;
a ring gear coupled to the set of planet gears, the ring gear having a plurality of inner teeth and a plurality of outer teeth, the plurality of inner teeth being in operational communication with each of the planet gears;
a sun gear coupled to the set of planet gears, the sun gear being concentrically disposed within the ring gear adjacent the planet carrier and being in operational communication with each of the planet gears;
an output shaft coupled to the sun gear, the output shaft lying coaxially with the input shaft;
a generator gear coupled to the ring gear, the generator gear being in operational communication with the plurality of outer teeth; and
a generator coupled to the generator gear, the generator having a generator drive shaft centrally coupled through the generator gear.

2. The planetary gear set transmission apparatus of claim 1 further comprising:
a shaft gear coupled to the output shaft, the output shaft extending centrally through the shaft gear;
a motor gear coupled to the shaft gear, the motor gear being in operational communication with the shaft gear;
a motor coupled to the motor gear, the motor having a motor drive shaft centrally coupled through the motor gear; and
an electric controller, the electric controller being in operational communication with each of the generator and the motor to draw energy from the generator to power the motor.

3. The planetary gear set transmission apparatus of claim 1 further comprising an outer end of each of the arms of the planet carrier being rounded and a span between each of the arms being concave outwards.

4. The planetary gear set transmission apparatus of claim 1 further comprising the set of arms being four arms.

5. A planetary gear set transmission apparatus comprising:
a planet carrier, the planet carrier having a carrier outer side and a carrier inner side, the planet carrier having a set of four evenly spaced arms, an outer end of each of the arms being rounded and a span between each of the arms being concave outwards;
an input shaft coupled to the planet carrier, the input shaft being coupled to the carrier outer side and configured to be connected to an engine;
a set of planet gears coupled to the planet carrier, each planet gear having a planet axle rotatably coupled to the carrier inner side of one of the arms of the planet carrier;
a ring gear coupled to the set of planet gears, the ring gear having a plurality of inner teeth and a plurality of outer teeth, the plurality of inner teeth being in operational communication with each of the planet gears;
a sun gear coupled to the set of planet gears, the sun gear being concentrically disposed within the ring gear adjacent the planet carrier and being in operational communication with each of the planet gears;
an output shaft coupled to the sun gear, the output shaft lying coaxially with the input shaft;
a generator gear coupled to the ring gear, the generator gear being in operational communication with the plurality of outer teeth;
a generator coupled to the generator gear, the generator having a generator drive shaft centrally coupled through the generator gear;
a shaft gear coupled to the output shaft, the output shaft extending centrally through the shaft gear;
a motor gear coupled to the shaft gear, the motor gear being in operational communication with the shaft gear;
a motor coupled to the motor gear, the motor having a motor drive shaft centrally coupled through the motor gear; and
an electric controller, the electric controller being in operational communication with each of the generator and the motor to draw energy from the generator to power the motor.
